(19) United States
(12) Patent Application Publication
(10) Pub. No.: US 2026/0315316 A1
(43) Pub. Date: Oct. 15, 2026

(54) Magnetic Field Guide Device and Method for Changing Magnetic Field State of Target Object

(71) Applicant: Beijing Wanhua Technology Co. Ltd., Beijing (CN)

(72) Inventor: Wenjun Fu, Beijing (CN)

(21) Appl. No.: 19/675,914

(22) Filed: May 13, 2026

Related U.S. Application Data
(63) Continuation-in-part of application No. 18/033,782, filed on Oct. 20, 2021, now Pat. No. 12,633,439.

(30) Foreign Application Priority Data
Oct. 27, 2020 (CN) CN202011161258.1
Oct. 20, 2021 (WO) PCT/CN2021/124965

(51) Int. Cl. A61H 39/08

(52) U.S. Cl. CPC A61H 39/086; A61H 2201/1207

(57) ABSTRACT

A magnetic field guide device comprising a magnetic field guide head defining a first border gradually converging in a first direction. During use, the device is proximate or connected to a target object requiring a change in a magnetic field state.

### REFERENCE TO RELATED APPLICATIONS

The present Patent Application is a Continuation-In-Part (“CIP”) of a Division of U.S. Ser. No. 18/033,782 filed Apr. 25, 2023, which, in turn, is based on PCT/CN2021/124965 filed Oct. 20, 2021, which, in turn, is based on CN 202011161258.1 filed Oct. 27, 2020, each hereby incorporated by reference for purposes of priority pursuant to Title 35, U.S. Code, § 119, and § 120, and § 121.

### FIELD

The present disclosure generally relates to methods and devices for changing magnetic field states of target objects and particularly relates to a device configured to be capable of guiding a magnetic field and a biological field along a specific direction, and a method for changing a magnetic field state of a target object.

### BACKGROUND

Plasma is a state of matter resulting from one of the other three states of matter (often, the gaseous one) having undergone an appreciable degree of ionization. (Wikipedia.) Thus, plasma consists of a significant portion of charged particles (ions and/or electrons as well as charged molecules). (Id.) While rarely encountered on Earth, it is estimated that 99.9% of all ordinary matter in the universe is plasma. (“Plasma, Plasma, Everywhere!”. NASA. Retrieved 23 Jun. 2025.) Stars are almost pure balls of plasma, and plasma dominates the rarefied intracluster medium and intergalactic medium. (Piel, A. (2010). Plasma Physics: An Introduction to Laboratory, Space, and Fusion Plasmas. Springer. pp. 4-5. ISBN 978-3-642-10491-6. Archived from the original on 5 Jan. 2016; and see also Aschwanden, M. J. (2004). Physics of the Solar Corona. An Introduction. Praxis Publishing. ISBN 978-3-540-22321-4.) Plasma is artificially generated, for example, by heating a neutral gas or subjecting it to a strong electromagnetic field. (Chiuderi, C. ; Velli, M. (2015). Plasma Astrophysics Basics. Springer. p. 17. ISBN 978-88-470-5280-2.) The presence of charged particles makes plasma electrically conductive, with the dynamics of individual particles and macroscopic plasma motion governed by collective electromagnetic fields and very sensitive to externally applied fields. (Morozov, A. I. (2012). Introduction to Plasma Dynamics. CRC Press. p. 30. ISBN 978-1-4398-8132-3.) Response of plasma to electromagnetic fields is used in many modern devices and technologies, including but not limited to plasma televisions as well as plasma etching. (Chu, P. K. ; Lu, XinPel (2013). Low Temperature Plasma Technology: Methods and Applications. CRC Press. ISBN 978-1-4665-0990-0.)

Magnetic fields are ubiquitous throughout the real world, ranging from the Earth and the stars to the directional motion of electrical charges, all of which have been observed to be capable of generating magnetic fields. Indeed, within human bodies, bioelectric activities generate complex biological fields in tissues and organs.

The biological fields have many characteristics: for example, magnetism generates electricity, that is, the motion of a conductor cutting magnetic induction lines in a magnetic field can generate a current; and electricity generates magnetism, that is, a circular magnetic field is generated around an energized conductor, and when a current in the conductor is stronger, the generated magnetic field is stronger.

U.S. publication 2008/0042785 to Yagisawa discloses an inductor circuit board made compatible with broadband by reducing capacitance of an inductor. The inductor circuit board is comprised of a flexible substrate made of a material, such as polyimide or liquid polymer, a transmission line formed on the flexible substrate, and an inductor. The inductor has a three-dimensional conical structure in which component inductors having different inductances are continuously connected to each other, with one end thereof connected to a portion of the transmission line between an input end and an output end thereof, and which is formed according to a transmission line pattern by wiring on a plurality of surface layers of the flexible substrate and connecting portions wired on the surface layers by vias that connect between the layer surfaces of the substrate, such that the inductor is expanded in a fan-like manner when distally spaced from the one end connected to the transmission line. A portion of the inductor closer to the transmission line has a lesser inductance, and a portion of the same further from the transmission line has a greater inductance.

CN 210745638U, directed to a utility model, discloses a needle-shaped self-emitting magnetic field generator, belonging to the technical field of magnetic field generators. The needle-shaped self-emitting magnetic field generator includes a shielding housing, a needle, and a magnetic conduction component. The needle is arranged at a front end portion of the shielding housing. A cavity for storing plasma liquid is provided inside the shielding housing. The magnetic conduction component is installed inside the cavity. The magnetic conduction component includes a conical spiral coil. A small end of the conical spiral coil is in contact with the needle. When the plasma substance liquid is excited, it can generate a magnetic field, and the magnetic field is conducted along the magnetic conduction component to the needle, where a magnetic field is formed. The utility model, able to select different plasma substance liquids according to different magnetic field strengths and coverage ranges, has an advantage of portability and adjustable magnetic induction intensity; at the same time, multiple units can be combined for use, for meeting different needs.

Magnetic fields are directionally oriented. Seen from directional orientation of magnetic fields about permanent magnets and directional features of geomagnetic fields about the Earth, magnetic field densities located about both poles of a magnet or the Earth are maximally arranged, while magnetic field densities between the poles of a magnet or near the equator of the Earth are minimal. Thus, magnetic fields define a diffuse shape ranging from high to low density or spacing between adjacent field lines between the poles. Also, the closed-loop trajectory of a planet orbiting our sun and our sun orbiting its Milky Way galaxy trajectory are believed to present a conically spiraling-motion closed-loop trajectory about a galactic center, which is believed to define a wedge shape when viewed from a distanced-planar perspective, where essential characteristics of the universe are believed secretly hidden. In the prior art, however, there is no application for using such diffuse shape and directional feature of a magnetic field and/or a conical spiral feature to change a spatiotemporal field state of an object. In view of such absence, the inventor proposes a method for changing a baseline magnetic field state of a target object by combining a magnetic field characteristic and a planetary conically spiraling trajectory, to invent a magnetic field guide device, which is useful, practical, and applicable in changing a biological and/or magnetic field, electric field, and/or another characteristic field of the objects.

### SUMMARY

In view of defects of the prior art, a technical problem to be solved by the present disclosure is to provide a magnetic field guide device. After provision of the device, a magnetic field about a position, where the device is provided can be guided along a specific direction, thus implementing innovative applications in changing magnetic fields of various materials and adjusting directions of the biological fields.

When considering changing a spatiotemporal field of an object in a plurality of fields by combining a density difference characteristic of spatial magnetic field distribution about a magnet and a shape of a planetary conical spiral trajectory, to put them to use, application, and practice, the present disclosure provides a magnetic field guide device and a method for changing a magnetic field state of a target object.

A magnetic-field guide device of the present subject matter as disclosed in this patent specification has a wedge-shaped magnetic-field guide head, wherein a magnetic-field guide-head border gradually converges along a preselected direction.

Electromechanical material designed, adapted, and configured to be a magnetic-field guide head comprises an electrical conductor. The magnetic field guide head comprises a plurality of communicating portions and an operatively associated plurality of interfering portions. The plurality of interfering portions are designed, adapted, and configured to be operatively associated with the plurality of communicating portions sequentially along a preordained communicating direction. A plurality of interfering portion borders converge along a communicating direction.

Also, the magnetic field guide device further includes a carrier, whereby the carrier is operatively connected to the magnetic field guide head and retractably extendable along a communicating direction of the plurality of interfering portions.

Optionally, plural interfering portions of the magnetic field guide device are designed, adapted, and configured to be located on separate planes respectively.

Further, an interfering portion located at one end of the magnetic field guide head is operatively connected to the carrier, whereupon an opposite end portion of the magnetic field guide head is distally spaced from the from the carrier.

Optionally, the magnetic field guide device plurality of interfering portions and associated plurality of communicating portions can be located on a single plane.

Moreover, each one of the plurality of interfering portions and each one of the plurality of communicating portions are each separately connected to the carrier.

Also, the magnetic field guide head is designed to be made of a polymeric or elastomeric material, whereby a converging direction of the magnetic field guide head is adaptable and configurable to be reciprocally alterable by an external force.

And at least one end portion of the magnetic field guide head is operatively connected to an electrical current device, such as, a pulsed electrical current device.

Yet another feature of the present disclosure is directed to a method for changing a magnetic field state, whereupon, a magnetic field guide device, placed proximate or connected to a target object, requires a change in a magnetic field state.

Further, the present disclosure provides at least the following advantages:
(1) The present disclosure employs a simple design to direct a variable value for an induced magnetic field passing through the magnetic field guide device spanning from a minimum-border interfering end portion to a maximum-border interfering end portion. When the minimum-border interfering end portion is proximate or connected to the target object, the effect of guiding the magnetic field of the target object along a direction from a convergence end to a diffusion end of the magnetic field guide device is achieved; and when the maximum-border interfering end portion is proximate or connected to the target object, the effect of guiding the magnetic field of the target object along the direction from the convergence end to the diffusion end of the magnetic field guide device is achieved.
(2) If a plurality of magnetic field guide devices are proximate or connected to the target object and maximum-border interfering portions of the plurality of magnetic field guide devices are guided along the same direction or directed along the same position, a likelihood of converging a stray magnetic field of a target object is achieved, and a focused magnetic field or a collective magnetic field is likely formed, thus increasing the possibility of effective use of an ordered magnetic field.
(3) When a minimum-border interfering end portion of a magnetic field guide device of the present disclosure is proximate or connected to a target object due to a directional characteristic of a magnetic field between a convergence end portion to a diffusion end portion, an ordered flow of electrically charged ions or molecules is formed within the target object, for promoting conductive, convective, and/or radiative heat transfer in the target object along the magnetic field guide device of the present disclosure. When the maximum-border interfering end portion of a magnetic field guide device is proximate or connected to the target object, because the directional characteristic of the magnetic field is directed from the convergence end portion to the diffusion end portion of a target object, whereby the electrically charged ionic motion and/or molecular motion within a target object is more active and stray, promoting a trend of increasing heat buildup in a target object.
(4) By changing the shape of the magnetic field guide device of the present disclosure, or instance, positions of interfering portions at both ends of the magnetic field guide head are constantly exchanged, whereby a magnetic field passing through the magnetic field guide device can be directed in completely opposite directions, thereby forming a reciprocating magnetic field having a frequency in a target object.
(5) By fixing one end portion of a magnetic field guide device of the present disclosure while generating an elastic vibration at the other end portion, a varying magnetic field intensity is induced, and thus, when proximate or connected to a target object, a magnetic field guide device can impose an active impact to the target object.
(6) By connecting both end portions of a magnetic field guide device to a pulse current device, the field guide device generates an intermittent directional pulse magnetic field, and therefore, when proximate or connected to a target object, the magnetic field guide device can impose a very active impact to the target object.
(7) By connecting an interfering end portion of a magnetic field guide device to a pulsed-current circuit, a guide strength of the magnetic field guide device of the present disclosure could be increased or suppressed by an intermittent current.

Brief Comparison Between Present Subject Matter and CN 210745638 U: The capture system and method of the present subject matter differs from the disclosure of CN 210745638 U in several ways. For example, CN 210745638 U is directed to a “pen type magnetic field emitter” while the present disclosure, in sharp contrast, is directed to and comprises a structure of conical spiral coil, providing the function of transmission for a plasma liquid and an elastic force to a syringe needle. It is an active system. The description for “pen type magnetic field emitter” suggests a source of magnetic field, a necessary condition, which cannot provide the function of emitting a magnetic field without a magnetic source (e.g., a plasma liquid). The present subject matter discloses a constructed passive system that operates relying on an induced magnetic field from a target object, back to modulate the target object magnetic field. A current technique is to apply an external magnetic field to a target object, sensitive to a magnetic field. My disclosure applies the target object internal magnetic to generate an induced magnetic field which is homologous with the target object. This is a key point for my method of changing the magnetic field state of a target object. In this way, the core theory of my disclosure differs from the prior art.

### BRIEF DESCRIPTION OF THE DRAWINGS

FIG. 1 depicts a vertically oriented side elevational view of a stereoscopic diagram of an embodiment of a magnetic field guide device of the present disclosure.

FIG. 2 depicts a major portion of the guide device embodiment of FIG. 1.

FIGS. 3 and 4 depict vertically oriented side elevational views of different helically wound embodiments of a stereoscopic diagram of a magnetic field guide device, contained in a partial cut-away enclosing structure, of the present disclosure.

FIG. 5 presents another embodiment of a magnetic field guide head of this disclosure, this embodiment shown in dash-dash line fashion in a reference diagram.

FIG. 6 is a front sectional diagram of the embodiment presented in FIG. 5.

FIGS. 7 and 8 are reference diagrams of an embodiment of the present disclosure in use, wherein FIG. 8 is an enlargement of a circled portion from FIG. 7.

FIG. 9 is a so-called “change-of-state” diagram of yet another embodiment of a magnetic field guide device of the present disclosure during its use, wherein State 1 is depicted on the left side and State 2 is depicted on the right side of FIG. 9.

FIG. 10 depicts a perspective view of another embodiment of a stereoscopic diagram of another magnetic field guide device of the present disclosure, wherein this embodiment is presented in a dash-dash line fashion within a reference diagram.

FIG. 11 is a reference diagram of another embodiment of a magnetic field guide device of the present disclosure, operatively coupled to a pulse current device.

### DETAILED DESCRIPTION

The technical means and associated technical information employed by the present disclosure to achieve the intended invention purpose is set forth below, in conjunction with the drawings and preferred embodiments of the present disclosure.

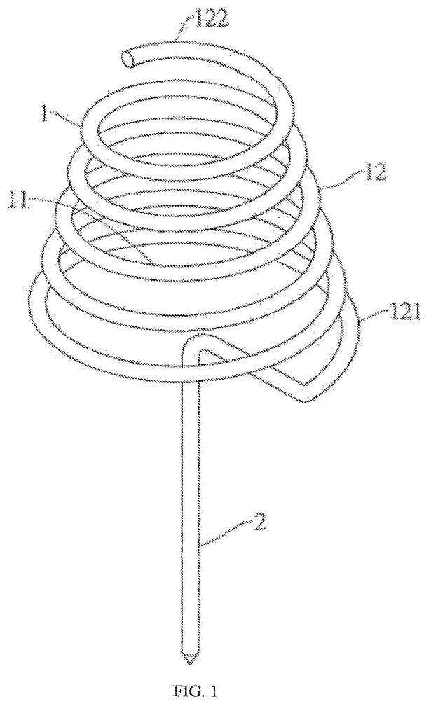

As shown in FIG. 1, the present disclosure depicts a vertically oriented magnetic field guide device, which includes a magnetic field guide head 1 and an associated carrier 2. Material of the magnetic field guide head 1 comprises a metal conductor. The magnetic field guide head 1 further comprises a plurality of helically wound communicating portions 11 as well as a plurality of interfering portions 12. All the interfering portions 12 are sequentially connected through the plurality of communicating portions 11 along a common communicating direction, and the borders of the plurality of interfering portions 12 gradually converge along the communicating direction. Carrier 2 is connected to the magnetic field guide head 1, and is extendable along the communicating direction of the interfering portions 12.

Specifically, a processing technique for the magnetic field guide head is not limited by the present disclosure. Indeed, for specific embodiments of the present disclosure, a magnetic field guide head 1 is designed to be integrally formed, mainly to save process flows. A sectional shape for interfering portions 12 may take various shapes such as triangular, square, and/or circular; and the present disclosure does not specify the sectional shape. The present disclosure also does not specify a connection mode and/or a position for a carrier 2 and/or a magnetic field guide head 1. Any instance where a magnetic field guide head 1 can be coupled to a magnetic field of a target object or a magnetic field guide head 1 could be fixed within a magnetic field of a target object falls within the scope of the present disclosure. The material of the carrier 2 can be selected, as needed; and is not limited in the present disclosure.

Each magnetic field guide device of the present disclosure is designed, adapted, and configured to be used in combination with an associated target object. When a convergence end portion or a diffusion end portion of a magnetic field guide device is proximate or connected to a target object, variable effects are imposed to the magnetic field of the target object. When a magnetic field guide device with a static magnetic field is proximate or connected to a target object, an adjustment effect may be imposed on the target object by relying on a change in the magnetic field of the target object and the action mode is relatively passive. When a magnetic field guide device with a dynamic magnetic field is proximate or connected to the target object, an adjustment effect may be imposed on a target object without relying on a change in the magnetic field of the target object, and such action mode is very active.

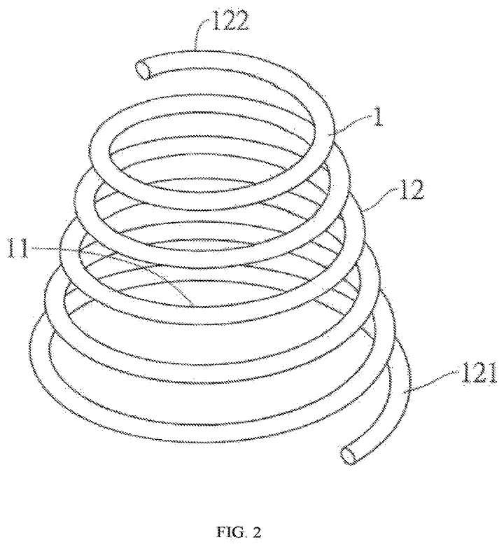

Shown in FIGS. 1 and 2, during use of a magnetic field guide device of the present disclosure, a magnetic field guide head 1 is placed in a target magnetic field by the carrier 2. A magnetic field flow space provided by a minimum-border interfering portion 122 is small, and as a border of interfering portions gradually expand, a magnetic field flow space also gradually increases, directing an induced magnetic field passing through the magnetic field guide device from a minimum-border interfering end portion 122 to a maximum border interfering end portion 121. When the minimum-border interfering end portion 122 of the magnetic field guide device is proximate or connected to the target object, the effect of guiding the magnetic field of the target object out of the target object along a direction from the convergence end to the diffusion end of the magnetic field guide device is achieved; and when the maximum-border interfering portion 121 of the magnetic field guide device is in proximity or connected to the target object, the effect of guiding the magnetic field of the target object into the target object along the direction from the convergence end to the diffusion end of the magnetic field guide device is achieved.

In another aspect of the present disclosure, when the minimum-border interfering portion 122 of a magnetic field guide device of the present disclosure is proximate or connected to a target object, due to a directional characteristic of a magnetic field from the convergence end portion to the diffusion end portion, an ordered flow of electrically charged ions and/or electrically charged molecules is formed within the target object, thereby promoting export and transfer of heat from within a target object along the magnetic field guide device of the present disclosure. When the maximum-border interfering portion 121 is proximate or connected to the target object, since the directional characteristic of the magnetic field from the convergence end portion to the diffusion end portion is directed toward the target object, electrically charged ionic and/or molecular motion within the target object becomes more active and stray, promoting a trend of increased heat in a target object.

Technical content of the present disclosure is described below in greater detail in conjunction with specific embodiments of the magnetic field guide device.

### Embodiment 1

In the embodiment shown in FIGS. 1 and 2, a magnetic field guide head 1 is integrally formed with a stainless-steel material. A plurality of communicating portions 11 and a plurality of interfering portions 12 together constitute an upward helically oriented or spirally oriented conical structure. Spiral radii of a plurality of interfering portions 12 are designed, adapted, and configured to gradually decrease, achieving an effect of converging interfering portions 12. The interfering portions 12 are also all located on different planes. The carrier 2 is a stainless-steel needle, which, in this embodiment, is connected to maximum-border interfering portion 121 and is spaced from a minimum-border interfering portion 122. During use, carrier 2 is caused to pierce a human body acupoint, as an acupuncture needle, and a magnetic field guide head 1 is used to guide a weak biological field at a human body acupoint location to the maximum-border interfering portion 121. That is, the biological field is guided in a preselected direction toward a human body, for achieving the effect of back vibration on the acupoint location. Optionally, in this embodiment, carrier 2 can also be connected to the minimum border interfering portion 122, spaced from the maximum-border interfering portion 121. After carrier 2 pierces the human body, the magnetic field guide head 1 may be used to guide the weak biological field at the human body acupoint location to the maximum-border interfering portion 121, achieving an effect of directionally guiding the biological field out the human body.

In this embodiment, the carrier 2 could also take the form of a sterile acupuncture needle, as shown in the prior art, and could be connected to a maximum-border interfering portion 121 or a minimum-border interfering portion 122 of the magnetic field guide head 1, as shown in FIG. 2 by means of a buckle connection, a clamp connection, or a sleeve connection. A connection mode is not particularly limited in this embodiment, and any case where the magnetic field guide head 1 is connected to the acupuncture needle would fall within the scope of this embodiment.

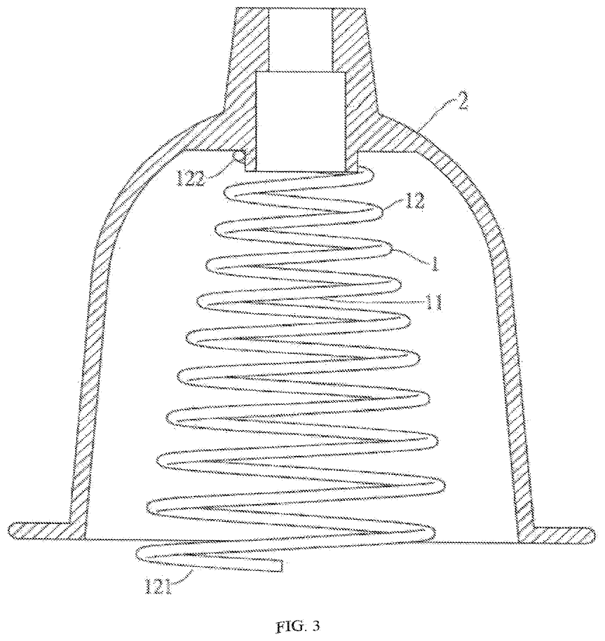

As shown in FIG. 3, a carrier 2 of the present disclosure may take the shape of a cup or enclosing structure defining an internal and generally “U” shaped upper end portion unitary with a minimum-border interfering end portion 122 of the magnetic field guide head 1. The maximum-border interfering end portion 121 is distally spaced from the internal “U” shaped upper end portion of the cup or enclosing structure defining an internal and generally “U” shaped upper end portion of the carrier 2 that protrudes from the “U” shaped bottom end portion of the cup. During use, the cup is attached along a flanged radially outwardly disposed lower end portion of the carrier 2 to the skin of a human subject or patient, and the maximum-border interfering portion 121 is in contact with the human skin to achieve the effect of guiding a biological field in a direction directed toward the human body.

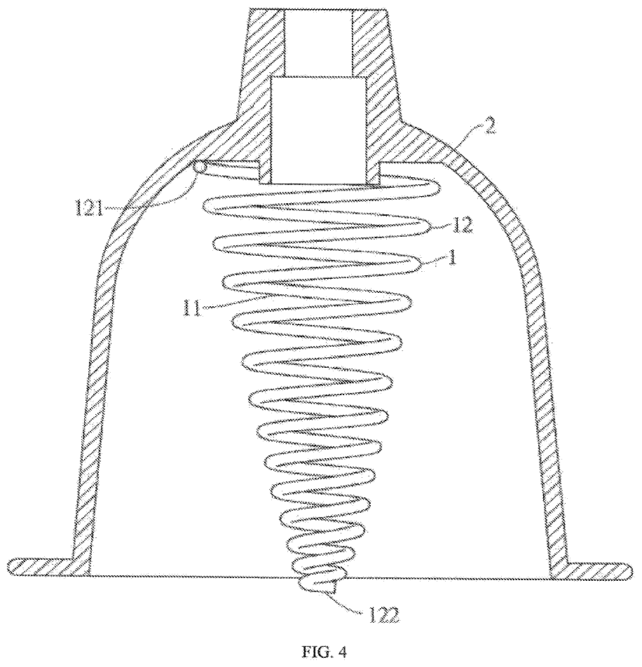

As shown in FIG. 4, the interfering portion 121 of the magnetic field guide head 1 is operatively connected to the “U” shaped upper end portion of the cup of the carrier 2 protruding from the “U” shaped bottom end portion of the cup, and the interfering portion 122 is in contact with the human skin, for achieving an effect of directionally guiding at least a portion of a biological field from the body of a patient.

In Embodiment 1, an above-described connection mode and a connection position of the carrier 2 can be adjusted according to predetermined requirements including a required magnetic field direction and are not limited in this embodiment.

### Embodiment 2

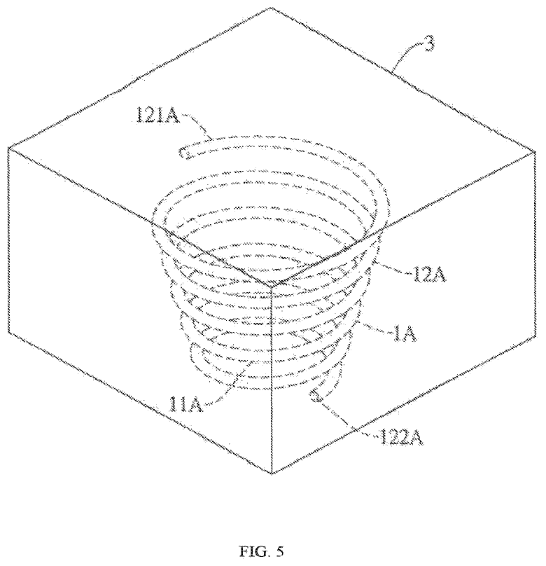

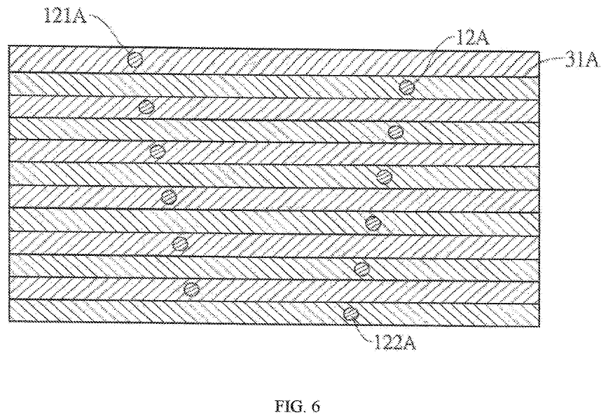

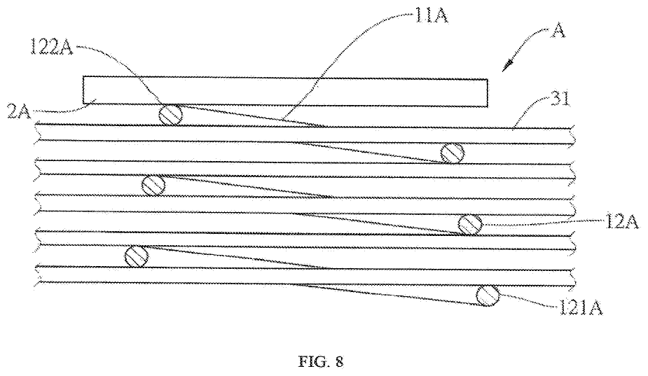

For this embodiment, partly shown in FIGS. 5 and 8, a magnetic field guide head 1A of a magnetic field guide device A (FIG. 8) is the same as shown in and described for Embodiment 1. A carrier 2A is characterized as a heat-conducting cylindrical structure, operatively connected to a minimum-border interfering portion 122A and distally spaced from a maximum-border interfering end portion 121A. The magnetic field guide head 1A is placed in an insulating material 3 during use. As shown in FIG. 8, an insulating layer 31 is disposed between adjacent interfering portions 12A (FIGS. 6 and 8), and a communicating portion 11A (FIGS. 5 and 8) passes through the insulating layer 31 to communicate two adjacent interfering portions 12A. Because of such design, a spatial structure in which the borders of the interfering portions 12A converging along a predetermined direction can be maintained even when the interfering portions 12A (FIGS. 5, 6, and 8) of the magnetic field guide head 1A are compressed into a planar state. In this way, when the carrier 2A is in contact with a heat-generating source, heat export in a direction opposite to a convergence direction of the interfering portions 12A can be promoted.

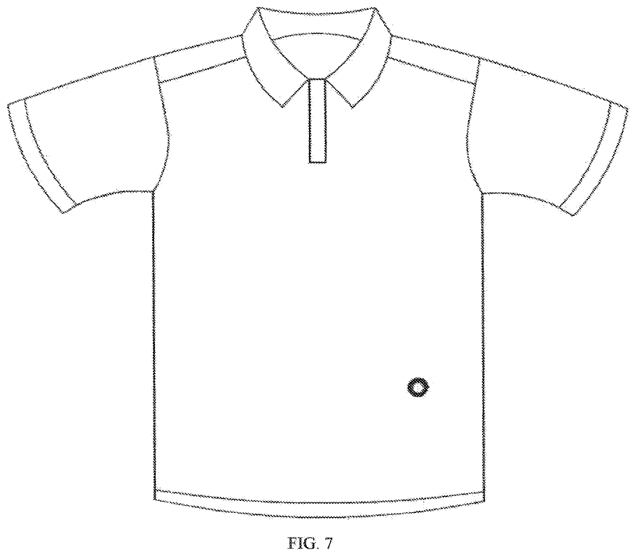

FIGS. 7 and 8 show an application of this embodiment in a heat-dissipation technology designed, adapted, and configured for clothing. A plurality of magnetic field guide devices A (FIG. 8) are placed on clothing fabric, and carrier 2A is in contact with human skin. Material for an insulating layer 31 is a material constituting clothing, including but not limited to cotton and/or linen. During wearing of the clothing, the carrier 2A is configured to transfer heat generated by a human body to the magnetic field guide head 1A, and a directional heat conduction function of the magnetic field guide head 1A promotes transfer of heat out of the body. By placing the device of this embodiment in an insulating layered structure and connecting the device to a heat source such as a chip or a circuit board by means of the carrier 2A, heat of the layered structure such as the chip or the circuit board can be dissipated.

In this embodiment, if a maximum-border interfering end portion 121A is connected to a carrier 2A, the device put into clothing interlined with the carrier 2A in contact with the body of a human, and a magnetic field having a directional characteristic from a convergence end portion to a diffusion end portion is directed to the body of the human. Electrically charged ionic and/or molecular motion within the body of the human wearer becomes more pronounced and active and yet stray, thus implementing the function of promoting an increase of heat within the body of the human for achieving a purpose of using the clothing to heat the body of a wearer.

### Embodiment 3

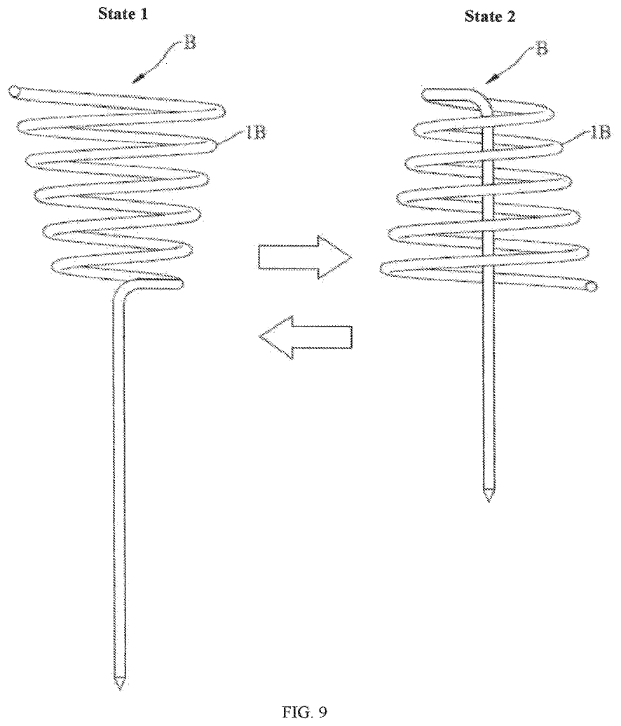

As shown in FIG. 9, a magnetic field guide device B in Embodiment 3 resembles the magnetic field guide device of Embodiment 1, except a magnetic field guide head 1B is made of an elastomeric material. Under action of an external force, the magnetic field guide head 1B reciprocally oscillates between state 1 and state 2. A magnetic field passing through magnetic field guide device B can be directed to opposite directions, to form reciprocating magnetic field frequency of a target object.

### Embodiment 4

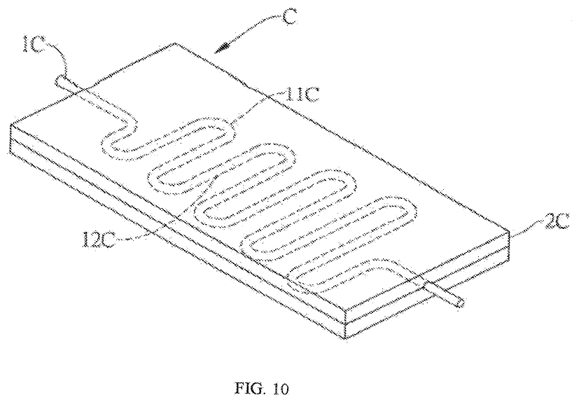

In this embodiment, the material of a magnetic field guide head 1C of a magnetic field guide device C is metallic copper. Shown in FIG. 10, a magnetic field guide head 1C is integrally formed, wherein a plurality of communicating portions 11C and a plurality of interfering portions 12C form a seriatim-connected plurality of “S” shapes with gradually converging borders, end-to-end operative connections, a plurality of communicating portions 11C, and a plurality of interfering portions 12C—all located on the same plane. A carrier comprises an insulating patch 2C, a plurality of communicating portions 11C, and a plurality of interfering portions 12C—all attached to the patch 2C. During operation, a patch 2C is attached between two points on the skin of a human, as needed, so as to guide a weak biological field between the two points in a direction opposite a converging direction of the magnetic field guide head 1C, to achieve preselected therapeutic and/or health-care activities.

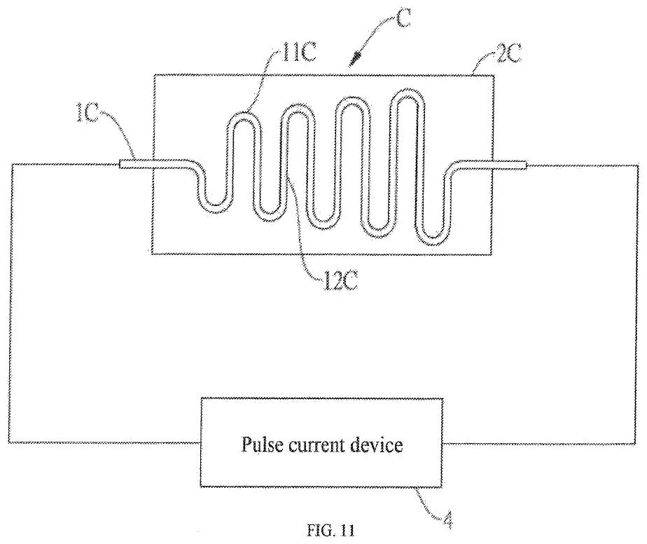

Referring to FIG. 11, both ends of a magnetic field guide device C in this embodiment are shown operatively connected to a pulsed current device 4, so that a magnetic field guide head 1C effectively generates a preselected pulsed current, for effectively generating an intermittent pulsed magnetic field value, so that when patch 2C is attached between two points on human skin, a static biological field between the two points on the skin is effectively guided in a direction opposite a convergence direction of the magnetic field guide head 1C, for achieving an active impact there.

In Embodiment 4, in addition to actively operatively connecting a magnetic field guide device to a pulse current device of the present disclosure, a constantly varying magnetic field can be directionally guided to a site of a human body by connecting both ends of a magnetic field guide device to an external constantly varying magnetic field varying device, e.g., a rotating or swinging magnetic field device, for affecting a biological field on the body of a human subject and/or patient.

The present disclosure has the following advantages:
(1) The present disclosure employs a simple design to induce a magnetic field to pass from a minimum-border interfering end portion to a maximum-border interfering end portion through a magnetic field guide device. When the minimum-border interfering end portion is proximate or connected to a target object, an effect of guiding a magnetic field of a target object in a direction from a convergence end to a diffusion end of the magnetic field guide device is achieved. When the maximum-border interfering end portion end is proximate or connected to the target object, an effect of guiding a magnetic field of a target object in a direction from the convergence end to the diffusion end of the magnetic field guide device is achieved.
(2) If a plurality of magnetic field guide devices are proximate or connected to the target object, and if the maximum-border interfering portions of the plurality of magnetic field guide devices are directed along the same direction or along the same position, a strong effect of convergence of a stray magnetic field of the target object is achieved, and even a focused magnetic field or a collective magnetic field is formed, thus increasing a possibility of effective use of an ordered magnetic field.
(3) When the minimum-border interfering portion end of the magnetic field guide device of the present disclosure is proximate or connected to the target object, due to the directional characteristic of the magnetic field from the convergence end portion to the diffusion end portion, an ordered flow of electrically charged ions and/or molecules is formed within the target object, thereby promoting export of heat in the target object along the magnetic field guide device of the present disclosure. When the maximum-border interfering portion end of the magnetic field guide device is proximate or connected to the target object, because the directional characteristic of the magnetic field from the convergence end to the diffusion end is directed to the target object, the molecular motion within the target object becomes more active and stray, thus promoting a trend of increased heat in the target object.
(4) By changing the shape of the magnetic field guide device of the present disclosure, positions of the interfering portions located at both ends of the magnetic field guide head are constantly exchanged, and the magnetic field passing through the magnetic field guide device can be directed to completely opposite directions, thus forming a reciprocating magnetic field having a frequency in the target object.
(5) By fixing one end portion of the magnetic field guide device of the present disclosure while generating elastic vibration at the other end portion, a varying magnetic field having an intensity can be induced, and when proximate or connected to the target object, the magnetic field guide device can impact the object.
(6) By operatively connecting both ends of the magnetic field guide device to a pulsed current device, the magnetic field guide device generates an intermittent directionally pulsed magnetic field, and when proximate or connected to the target object, a magnetic field guide device can impose an active impact on a target object.
(7) By connecting the interfering portion at one end portion of the magnetic field guide device to a pulsed current circuit, guide strength of a magnetic field guide device of the present disclosure is increased or suppressed by an intermittent current.

The above descriptions are only preferred embodiments of the present disclosure, and do not impose any limitations on the present disclosure. Although the present disclosure includes the preferred embodiments, these embodiments are not intended to limit the present disclosure. Those skilled in the art can make some changes or modifications to the above disclosed technical content into equivalent embodiments with equivalent variations, without departing from the scope of the technical solution of the present disclosure. In addition, after research, the inventor finds that the method and the device involved in the present disclosure have the same effect mode at a more microscopic quantum level in similar application methods. In summary, therefore, any amendments, equivalent changes and/or modifications made to the above embodiments based on the technical essence of the present disclosure, without departing from the content of the technical solution of the present disclosure, still fall within the scope of a technical solution of the present disclosure.

What is claimed is:

1. A magnetic field guide device, comprising:
a magnetic field guide head defining a first border, wherein the border of the magnetic field guide head converges in a first predetermined direction;
a conductor;
a plurality of communicating end portions; and
a plurality of interfering end portions defining a second border, wherein each one of the plurality of interfering end portions is connected to an associated one of the plurality of communicating end portions in a second predetermined direction, wherein the border of the plurality of interfering end portions converge in a third predetermined direction, wherein the magnetic field guide device further includes a carrier connected to the magnetic field guide head, wherein the carrier is extendable and retractable along the third predetermined direction.

2. The magnetic field guide device of claim 1, wherein the plurality of interfering portions as well as the plurality of communicating portions are co-planar.

3. The magnetic field guide device of claim 1, wherein the plurality of interfering portions and the plurality of communicating portions are secured to the carrier.

4. The magnetic field guide device of claim 1, wherein the magnetic field guide head comprises an elastic material configured for enabling the first predetermined direction to be changed reciprocally by applying an external force thereto.

5. The magnetic field guide device of claim 1, wherein at least one end of the magnetic field guide head is operatively connected to a pulsed current device.

6. A method for changing a magnetic field state of a target object, comprising:
placing a magnetic field guide device proximate or connected to a target object,
wherein the object is adapted and configured to require a change in a magnetic field state,
wherein the magnetic field guide device comprises a field guide head defining a border, and
wherein the border gradually converges in a predetermined direction.

7. A method for changing a magnetic field state of a target object, comprising:
placing a magnetic field guide device proximate or connected to a target object,
inducing a magnetic field by the target object, and
interacting with the target object by requiring a change in the magnetic field state.

8. The method of claim 7, wherein the magnetic field guide device comprises:
a wedge-shaped magnetic field guide head, and
a border adapted and configured for the magnetic field guide head, wherein said border gradually converges along a specific direction.
